(19) United States
(12) Patent Application Publication
(10) Pub. No.: US 2026/0087944 A1
(43) Pub. Date: Mar. 26, 2026

(54) PELVIC EDUCATIONAL MODEL

(71) Applicant: GRANVILLE BIOMEDICAL INC., St. John's (CA)

(72) Inventor: Christine GOUDIE, St. John's, NL (CA)

(21) Appl. No.: 19/109,626

(22) PCT Filed: Sep. 8, 2022
(86) PCT No.: PCT/CA2022/051348

§ 371 Date: Mar. 7, 2025

(51) Int. Cl. G09B 23/30

(52) U.S. Cl. CPC G09B 23/30

(57) ABSTRACT

Provided herein is a female pelvic educational model and kits for use thereof in an anatomical simulation. The female pelvic educational model has main body with a front side and a back side, whereby the back side is configured to allow for the passage of light into the interior of the main body and a posterior canal to provide an illuminated main body cavity having one or more of an illuminated extended vaginal canal, an illuminated visible cervix and an illuminated visible cervix opening. Also provided is a stand for use with the female pelvic educational model.

### TECHNICAL FIELD

The present disclosure relates generally to a female pelvic educational model and kits for use thereof in an anatomical simulation, and in particular to a female educational model having an extended vaginal canal with an illuminated visible cervix and a stand for suitable alignment thereof.

### BACKGROUND

Life-like biomodels are used for a variety of purposes and in a variety of areas, such as for practice, training, teaching and/or as learning demonstration tools. In particular, life-like models are needed for procedural demonstrations with anatomical accuracy.

Female pelvic models are used by physicians, especially Pelvic Floor Physiotherapists (PFPs), as a demonstration tool to show the patients their anatomy, placement of devices in their bodies, and how certain medical and/or surgical procedures are conducted. Physicians also use female pelvic models as training instruments for medical students and residents. This poses significantly less risk than learning on live subjects and reduces costs as compared to learning on cadavers. Other professionals likewise rely on female pelvic models as practice and educational tools, such as sexual health educators, midwives, doulas, nurses, and healthcare students.

Without such models, teaching and educational tools using only verbal instructions, illustrations (published or hand drawn), hand gestures, puppets or even inflatable cubes, do not provide accurate demonstration and are simply impractical and inefficient. However, currently available female pelvic models suffer from a number of deficiencies. For one, many models in the field are rigid pelvic models that are not capable of certain procedural demonstrations, such as the insertion and removal of a speculum, menstrual cup, or birth control devices. For another, many models fail to accurately portray anatomical features in a suitable form, design or structure for educational purposes.

It is thus an object of the present disclosure to provide an improved female educational model.

### SUMMARY

The present disclosure provides a female pelvic educational model and kits for use thereof in an anatomical simulation. The present disclosure recognizes that there are problems in currently existing female pelvic models in respect of functionality and accuracy as an educational model.

An advantage of the present disclosure is the provision of female pelvic educational models having improved characteristics over existing technologies.

In an embodiment, the present disclosure relates to a female pelvic educational model comprising: a main body having a front side and a back side, the front side having a shape defining a vulva and comprising an opening to an interior of the main body; and the back side comprising an exterior surface and a tube-like structure extending outwards therefrom defining within a posterior canal, wherein the tube-like structure is open to the interior of the main body to form a vaginal canal with the opening in the front side, wherein inside the tube-like structure at or near the end distal to the back side are one or more striations, impressions, protrusions, conical structures, ring-like structures, or any combination thereof, defining one or both of a cervix and a cervix opening; and wherein the back side, or at least the tube-like structure of the back side, is configured to allow for the passage of light into the interior of the main body and/or the posterior canal to provide an illuminated main body cavity having one or both of an illuminated visible cervix and an illuminated visible cervix opening.

In an embodiment of the female pelvic educational model disclosed herein, the exterior surface of the back side is a flat surface bounded by the shape defining the vulva of the front side.

In an embodiment of the female pelvic educational model disclosed herein, the tube-like structure has a closed end distal to the back side of the main body.

In an embodiment of the female pelvic educational model disclosed herein, the wall formed by the closed end of the tube-like structure comprises one or more of a circular or oval striation, a circular or oval impression, a circular or oval protrusion, the conical structure, the ring-like structure, or any combination thereof, to define the cervix and the cervix opening.

In an embodiment of the female pelvic educational model disclosed herein, the circular or oval impression is a circular or oval dimple and/or circular or oval thinning of material defining the cervix opening. In an embodiment, the cervix is defined by two circular striations of different diameter.

In an embodiment of the female pelvic educational model disclosed herein, the cervix is defined by a single ring-like structure protruding axially outwards from an inner surface of the wall formed by the closed end. In an embodiment, the cervix opening is defined by an inner void space within the ring-like structure.

In an embodiment of the female pelvic educational model disclosed herein, the entirety of the back side is configured to allow for the passage of light into the interior of the main body and the posterior canal. In other embodiments, only the tube-like structure of the back side is configured to allow for the passage of light into the interior of the main body and the posterior canal.

In an embodiment, the female pelvic educational model of the present disclosure is configured to allow for the passage of light into the interior of the main body and the posterior canal by one or more of (i) the material of the back side being thinner than the material of the front side, (ii) the material of the back side having a lower pigment density than the material of the front side, and (iii) the material of the back side being a different colour than the material of the front side. In an embodiment, all three of these configurations are employed.

In an embodiment of the female pelvic educational model disclosed herein, the back side is a pink colour. In an embodiment, the front side is a flesh tone colour.

In an embodiment of the female pelvic educational model disclosed herein, the shape defining the vulva comprises: a smooth outer portion defining a labia majora; and a pliable vulvar opening formed by opposing flap-like structures defining labia minora, the pliable vulvar opening situated between the smooth outer portion, wherein an upper region within the pliable vulvar opening comprise a solid surface set internal to the labia majora and a lower region comprises the opening to the interior of the main body and allows for passage into the posterior canal defined by the tube-like structure.

In an embodiment of the female pelvic educational model disclosed herein, the smooth outer portion further comprises a circular crevice defining an anus, the circular crevice being below the pliable vulvar proximal to the lower region.

In an embodiment of the female pelvic educational model disclosed herein, the smooth outer portion further comprises a protruding ridge extending from a top of the main body to just above or between the opposing flap-like structures defining labia minora, the protruding ridge being proximal to the solid surface set internal to the labia majora and defining a clitoral hood with a clitoris at the position just above or between the opposing flap-like structures.

In an embodiment of the female pelvic educational model disclosed herein, the solid surface set internal to the labia majora comprises a circular inlet or depression defining a urethra.

In an embodiment of the female pelvic educational model disclosed herein, the main body is made of silicone with a Shore A value of between 0 and 30. In an embodiment, the smooth outer portion has a higher Shore value than the pliable vulvar opening.

In an embodiment of the female pelvic educational model disclosed herein, the main body has a tensile strength of about 200 psi and a 100% Modulus of about 10 psi.

In an embodiment of the female pelvic educational model disclosed herein, the main body has an elongation at break % of about 90%.

In an embodiment of the female pelvic educational model disclosed herein, the main body has a Die B tear strength of about 38 pli.

In an embodiment, the female pelvic educational model of the present disclosure further comprises a stand. In an embodiment, the stand orients the posterior canal defined by the tube-like structure at an angle of 30° to 60° relative to a surface on which the stand sits. In an embodiment, the angle is about 45°. In an embodiment, the main body sits upon and is detachably engaged to the stand. In an embodiment, the stand comprises a base and one or more legs, the base having an aperture to receive the tube-like structure of the main body. In an embodiment, the back side of the main body rests upon an inwardly recessed portion of the base, the inwardly recessed portion defining the aperture. In an embodiment, the inwardly recessed portion of the base is a depth sufficient for the front side to project and be positioned outside the recessed portion. In an embodiment, the stand comprises two legs, each of the two legs forming a triangle shape by interconnection with opposing ends of the base. In an embodiment, the stand comprises a sticky portion on a bottom surface of the one or more legs.

In another embodiment, the present disclosure relates to a kit for conducting anatomical simulations, the kit comprising: the female pelvic educational model as described herein; and a stand.

In an embodiment of the kit, the stand is a stand as described herein.

In an embodiment, the kit disclosed herein further comprises a procedural tool, a swab, a lubricating substance, a feminine hygiene product or applicator, or any combination thereof. In an embodiment, the procedural tool is a pap or pelvic exam instrument, a contraception device, a dilator device, a device for sexual health, a massage device, or a pelvic wand.

In an embodiment, the kit disclosed herein further comprises instructions for use of the female pelvic educational model in one or more anatomical simulations.

In another embodiment, the present disclosure relates to the use of the female pelvic educational model as described herein for performing an anatomical simulation.

Other aspects and embodiments of the disclosure are evident in view of the detailed description provided herein.

### BRIEF DESCRIPTION OF THE DRAWINGS

Further advantages, permutations and combinations of the present disclosure will now appear from the above and from the following detailed description of the various particular embodiments, taken together with the accompanying drawings, each of which are intended to be non-limiting and in which:

FIG. 1 is a front view of a female pelvic educational model according to an embodiment of the present disclosure.

FIG. 2 is a top view of the pelvic educational model shown in FIG. 1.

FIG. 3 is a bottom view of the pelvic educational model shown in FIG. 1.

FIG. 4 is a back view of the pelvic educational model shown in FIG. 1.

FIG. 5 is a side view of the pelvic educational model shown in FIG. 1.

FIG. 6 is a front view of an exemplary stand according to an embodiment of this disclosure.

FIG. 7 is a side view of the exemplary stand of FIG. 6.

FIG. 8 is a top view of the exemplary stand of FIG. 6.

FIG. 9 is a bottom view of the exemplary stand of FIG. 6.

FIG. 10 is a side view of the pelvic educational model shown in FIG. 1 being engaged with the exemplary stand of FIG. 6.

FIG. 11 is a colour photograph showing two exemplary female pelvic educational models according to embodiments of the present disclosure.

FIG. 12 is a closer view colour photograph of the exemplary female pelvic educational model on the right side in FIG. 11.

FIG. 13 is a closer view colour photograph of the exemplary female pelvic educational model on the left side in FIG. 11.

FIG. 14 is a colour photograph showing the side view of an exemplary female pelvic educational model of the present disclosure being engaged with an exemplary stand of the present disclosure.

FIG. 15 is a colour photograph showing the side view of an exemplary main body of a female pelvic educational model of the present disclosure, wherein the intersection between the front side and back side is evident by a change in colour of material from flesh tone (front side) to pink (back side).

### DETAILED DESCRIPTION

Unless otherwise defined, all technical and scientific terms used herein generally have the same meaning as commonly understood by one of ordinary skill in the art to which this disclosure pertains. Exemplary terms are defined throughout the present disclosure for ease in understanding the subject matter disclosed herein.

The present disclosure provides a female pelvic educational model and kits for use thereof in an anatomical simulation.

The present disclosure recognizes that there are problems in currently existing female pelvic models in respect of utility, functionality and accuracy as educational models. The female pelvic educational model of the present disclosure is advantageous in several aspects, including being an all-encompassing life-like model having an extended vaginal canal for procedural and product demonstrations, a visible cervix that is illuminated for improved educational purposes, a visible posterior canal that is also illuminated, a visible anus, anatomically accurate features, and a realistic look and feel.

Also advantageous is that the female pelvic educational model of the present disclosure has the features and functionality to provide a wide-range of utility across a number of difficult training, practice and educational applications. Unlike many models which are rigid and lack sufficient features to function as accurate educational tools, the female pelvic educational model of the present disclosure is realistic and life-like, including allowing for educational procedures involving suturing and/or insertion of various procedural tools.

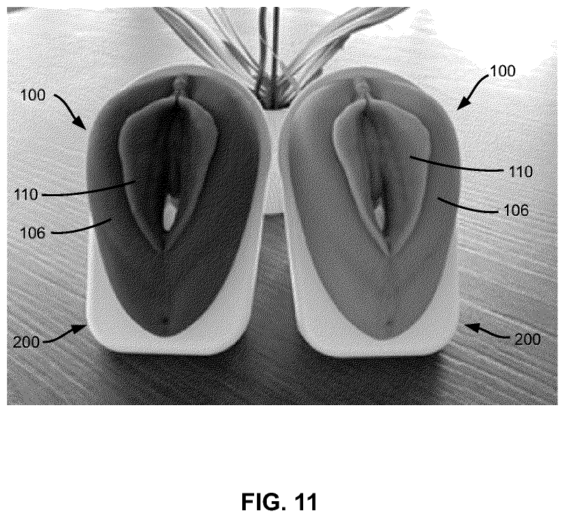

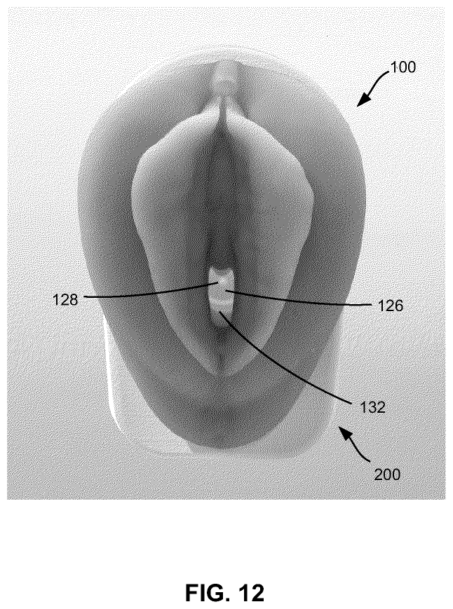

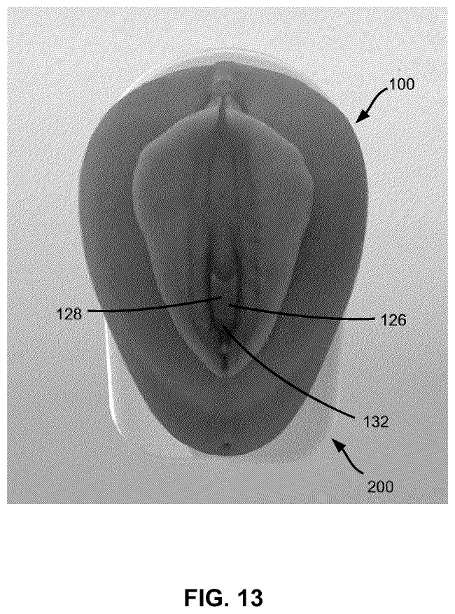

Particularly advantageous to its improved functionality as an educational model is the presence of an illuminated visible cervix and/or cervix opening. The female pelvic educational model of the present disclosure has a visible cervix and/or cervix opening at the end of an extended vaginal canal, and these features are illuminated to provide visual aid during anatomical simulations or other training, practice or educational applications (see e.g. FIGS. 11-13).

Another advantageous aspect of embodiments of the female pelvic educational model of the present disclosure is the configuration of the stand on which the model can rest. In an exemplary embodiment, the stand is of a design to orient the extended vaginal canal (posterior canal) at a preferred angle for anatomical simulations (e.g. an angle of between 30° to 60° relative to a surface on which the stand sits). In particular embodiments, the angle is 45°. This feature of providing a suitable angle, in combination with an illuminated visible vaginal canal, cervix and cervix opening offers significantly improved performance of the female pelvic educational model of the present disclosure across a wide-range of training, practice and educational applications.

Thus, the female pelvic educational model of the present disclosure offers a life-like and highly practical and accurate model for various healthcare professionals to demonstrate various techniques, including massage techniques, Pap/pelvic exams, contraception insertion and removal, female hygiene product insertion and removal, dilator usage, and devices for sexual health, pelvic wand usage, anatomy lessons, and pre-and post-natal care techniques. The female pelvic educational model of the present disclosure offers empowerment and confidence to patients and other users in making informed decisions about their bodies and personal health.

Reference will now be made to exemplary embodiments of the disclosure, wherein numerals refer to like components, examples of which are illustrated in the accompanying drawings that further show exemplary embodiments, without limitation.

In an embodiment, the present disclosure relates to a female pelvic educational model comprising: a main body having a front side and a back side, the front side having a shape defining a vulva and comprising an opening to an interior of the main body; and the back side comprising an exterior surface and a tube-like structure extending outwards therefrom defining within a posterior canal, wherein the tube-like structure is open to the interior of the main body to form a vaginal canal with the opening in the front side, wherein inside the tube-like structure at or near the end distal to the back side are one or more striations, impressions, protrusions, conical structures, ring-like structures, or any combination thereof, defining one or both of a cervix and a cervix opening; and wherein the back side, or at least the tube-like structure of the back side, is configured to allow for the passage of light into the interior of the main body and the posterior canal to provide an illuminated main body cavity having one or both of an illuminated visible cervix and an illuminated visible cervix opening.

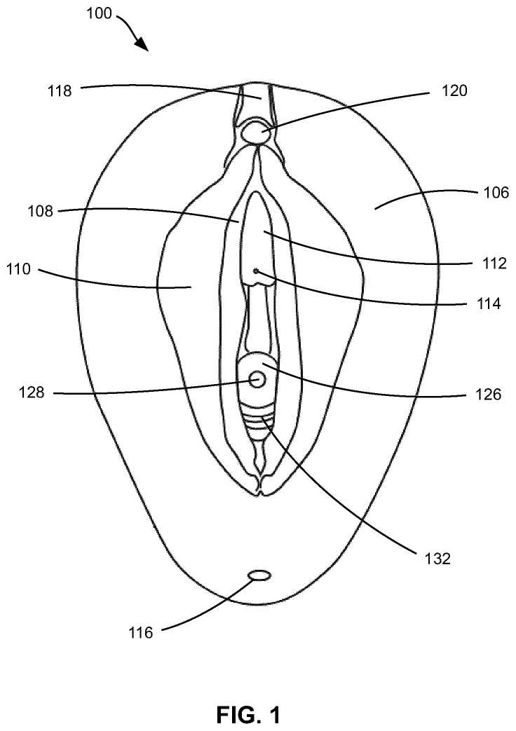

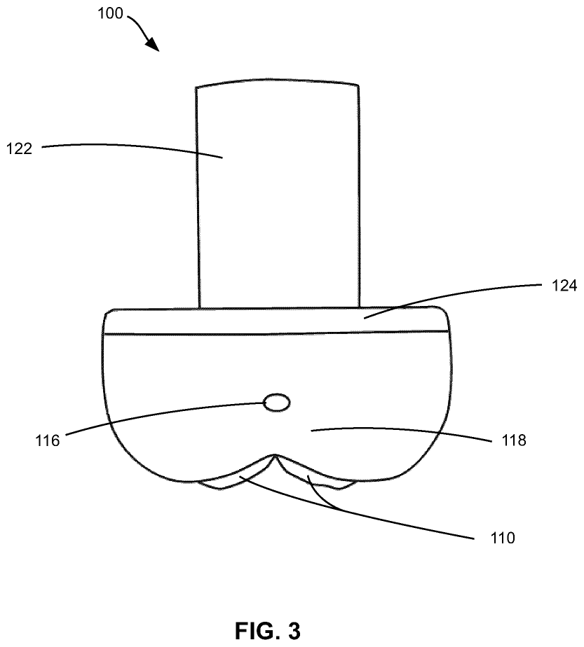

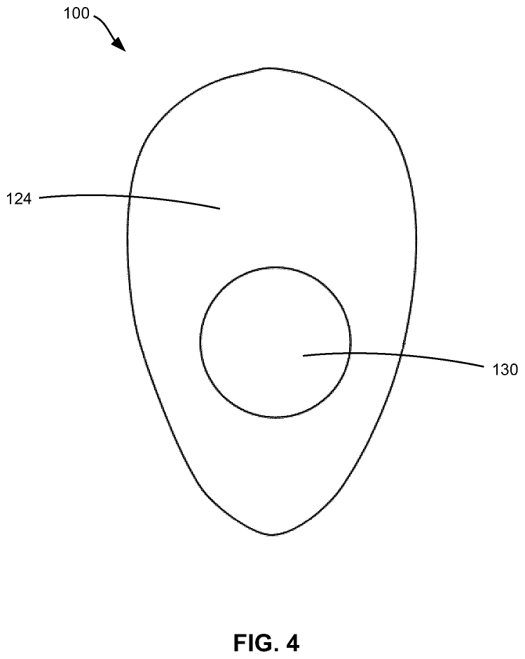

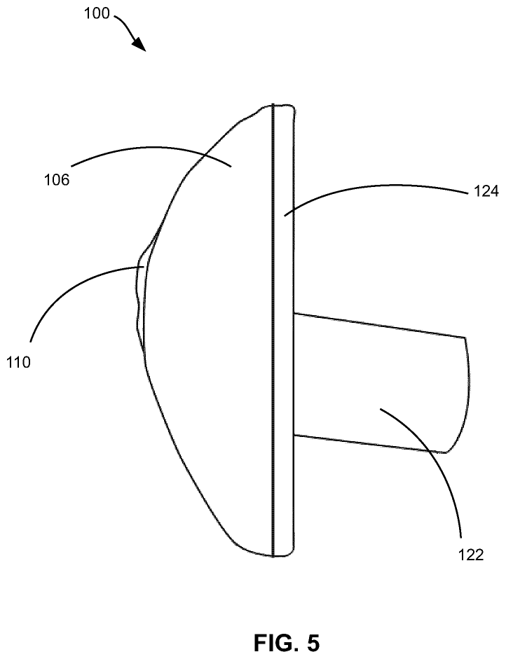

As shown in FIGS. 1-5, the main body 100 of the female pelvic educational model has a front side 102 and a back side 104. As used herein, the terms “front side” and “back side” are relative terms intending to refer to opposing or opposite sides of the main body 100. The front side 102 of the female pelvic educational model is the side having a shape defining a vulva. The back side 104 is the opposite side and in embodiments including a stand, is the side which is situated on the stand to orient the front side towards the user. In an embodiment, the main body 100 is a monolithic structure produced as one piece. Although produced in one piece, the main body 100 may comprise different materials and/or properties for different components. For example, the front side 102 may be made from a material having a different hardness or density than the back side 104, or different components of the front side 102 may have different properties (e.g. pliability). In an alternate embodiment, various portions of the main body 100 may be made separately and subsequently interconnected.

In an embodiment of the female pelvic educational model of the present disclosure, the shape of the portion of the main body defining the vulva (i.e. the front side; 100) comprises a smooth outer portion 106 defining a labia majora and a pliable vulvar opening 108 formed by opposing flap-like structures 110 defining labia minora. As would be well understood in respect of anatomy, the pliable vulvar opening 108 is situated between the smooth outer portion 106.

In some embodiments, the pliable vulvar opening 106 has an upper region comprising a solid surface 112 set internal to the labia majora. By “set internal”, it is meant that the solid surface 112 is recessed and positioned towards the interior of the main body 100 relative to the outmost surfaces of the smooth outer portion 106. In an embodiment, this solid surface 112 comprises a feature defining a urethra 114. In an embodiment, this feature defining the urethra 114 is a circular inlet or depression. By “circular inlet” it is meant a small circular crevasse or closed-ended hole. By “circular depression”, it is meant a less significant depression in the material of the main body 100 than would be the case for a circular inlet.

In some embodiments, the smooth outer portion 106 further comprises a circular crevice 116 defining an anus. By “circular crevice” it is meant a small circular hole into the surface of the smooth outer portion 106. In an embodiment, the circular crevice 116 is closed-ended and does not open into the interior of the main body 100. In other embodiments, the circular crevice 116 is open-ended and does open into the interior of the main body 100. In an embodiment, the circular crevice 112 is between about 2 mm and about 8 mm in diameter, in a resting non-expanded state. In an embodiment, the circular crevice 112 is about 3 mm, about 4 mm or about 5 mm in diameter, in a resting non-expanded state. In an embodiment, the circular crevice 112 is pliable and can be expanded to up to two times, three times, four times, or more larger in diameter. The circular crevice 112 is positioned on the smooth outer portion in a region at the bottom of the main body 100, below and proximal to the lower region of the pliable vulvar opening 108. As would be understood, the region on the smooth outer portion 106 between the circular crevice 112 and the pliable vulvar opening 108 is the perineum.

In an embodiment of the female pelvic educational model disclosed herein, the smooth outer portion further comprises a protruding ridge 118 extending from a top of the main body 100 to just above or between the opposing flap-like structures 110 defining labia minora. In terms of anatomy, the protruding ridge 118 defines a clitoral hood. At a region proximal to the solid surface 112, the protruding ridge 118 comprises and defines a clitoris at a position just above or between the opposing flap-like structures 110. In the female pelvic educational model of the present disclosure, the clitoris may be defined by a circular or oval flat spot 120 at or near the end of the protruding ridge 118 adjacent the opposing flap-like structures 110.

In an embodiment, the size of the front side 102 of the main body 100 may be between about 7.5 cm and about 20 cm from top to bottom. By “top”, it is intended to refer to the outer edge at the region described herein as having the protruding ridge 118 (in embodiments where this feature is present). By “bottom”, it is intended to refer to the outer edge at the region described herein as having the circular crevice 116 (in embodiments where this feature is present). In an embodiment, the size of the front side 102 of the main body 100 may be between about 10 cm and about 15 cm from top to bottom. In an embodiment, the size of the front side 102 of the main body 100 may be between about 5 cm and about 10 cm from side to side. By “side to side” it is meant the widest distance at outer edges of the front side 102 of the main body 100 measured along a line perpendicular to the top to bottom measurement.

The pliable vulvar opening 108 further comprises an opening to the interior of the main body 100. In an embodiment, this opening is in a lower region of the pliable vulvar opening 108, positioned below the solid surface 112 in the upper region. For realistic, life-like accuracy, the opening is pliable. The opening provides access to the interior of the main body 100 and allows for passage into the vaginal canal of the female pelvic educational model of the present disclosure.

The vaginal canal of the female pelvic educational model is an extended vaginal canal provided by a combination of features, including the interior space of the main body 100 and the posterior canal defined by and within the tube-like structure 122 of the back side 104.

With respect to the back side 104 of the main body 100 of the female pelvic educational model of the present disclosure, the back side 104 comprises an exterior surface 124 and a tube-like structure 122 extending outwards therefrom. By “exterior surface”, it is meant to refer to the surface facing the opposite direction to the orientation of the vulva of the front side 102. The exterior surface defines and provides a back face surface to the main body 100. In an embodiment, the exterior surface 124 is a flat surface. In other embodiments, the exterior surface may be slanted or curved, and/or may include structural features such as ridges, bumps, recesses, or protrusions. Any one or more of these features may be used to position, retain and/or orient the main body 100 in a stand, preferably in a detachable manner.

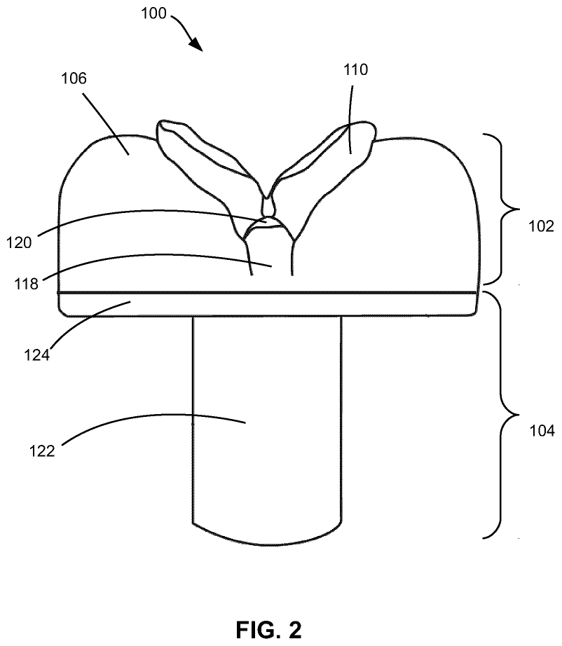

By “extending outwards therefrom”, it is meant that the tube-like structure 122 extends backwards in an opposite direction to the front side 102 of the main body 100, such as shown in FIG. 2. By “tube-like structure”, it is meant a circular, oval or similar shaped tube having a passageway therein along its longitudinal length. In an embodiment, the tube-like structure is a circular tube. In an embodiment, at the end distal to the exterior surface 124 of the back side, the tube-like structure 122 has a closed end. At the end that interconnects with the exterior surface 124 of the back side, the tube-like structure 122 is open ended and the posterior canal defined by the tube-like structure is accessible from the opening of the pliable vulvar opening 108.

In an embodiment, the exterior surface 124 of the back side 104 is bounded by the shape defining the vulva of the front side 102. By “bounded by the shape”, it is meant that the outer wall boundary of the exterior surface does not extend past the outer surfaces of the front side 102. In this manner, the front side 102 and back side 104 form a uniform shape with a smooth surface transition from the front side 102 to the back side 104, such as shown in FIGS. 1-5. In other embodiments, the exterior surface 124 of the back side 104 may extend further outwards and past the outer surface of the front side 104 where the two interconnect. Alternatively, the exterior surface 124 of the back side 104 may be recessed inwards from the outer surface of the front side 104 where the two interconnect.

In some embodiments, such as for example when the tube-like structure 122 has a closed end distal to the back side 124, inside the tube-like structure 122 at the end distal to the back side 124 are one or more striations, impressions, protrusions, conical structures, ring-like structures, or any combination thereof, defining one or both of a cervix 126 and a cervix opening 128. The striations, impressions or protrusions may be of any suitable shape to define the cervix 126 and/or the cervix opening 128. In an embodiment, the striations, impressions or protrusions are circular or oval striations, circular or oval impressions, circular or oval protrusions, or any combination thereof. In a particular embodiment, the striations, impressions or protrusions are circular striations, circular impressions, or circular protrusions.

In an embodiment, the wall formed by the closed end of the tube like structure comprises one or more of a circular or oval striation, a circular or oval impression, a circular or oval protrusion, the conical structure, the ring-like structure, or any combination thereof, to define the cervix 126 and/or the cervix opening 128.

The striations, impressions, protrusions, conical structures and/or ring-like structures, and any combination thereof, provide context to the wall of the closed-end 130 of the tube-like structure 122 to portray and render visible structures representing one or both of the cervix 126 and the cervix opening 128. For example, in an embodiment, the circular or oval striations may form ridges on the wall of the closed-end 130 of the tube-like structure 122 that appear darker than the surrounding surfaces, to thereby make visible circles that define the cervix 126 and/or the cervix opening 128. In an embodiment, the cervix is defined by two circular or oval striations of different diameter.

In other or the same embodiments, circular or oval impressions in the wall of the closed-end 130 of the tube-like structure 122 may be used. The circular or oval impressions may be any structure that provides a visual representation of the cervix 126 and/or the cervix opening 128 in the wall of the closed-end 130 of the tube-like structure 122. For example, in an embodiment, the circular or oval impression may be a circular or oval dimple or depression in interior side of the wall of the closed-end 130 of the tube-like structure 122. The circular or oval dimple or depression may or may not change the thickness of the wall of the closed-end 130 of the tube-like structure 122. For example, the exterior surface of the wall of the closed-end 130 of the tube-like structure 122 may project outwards an amount defined by the interior dimple or depression to maintain the same thickness, or it may not. The circular or oval dimple or depression may also be structured in the reverse manner, with the dimple or depression on the exterior side of the wall of the closed-end 130 of the tube-like structure 122. In such instances, the interior surface of the wall of the closed-end 130 of the tube-like structure 122 may project inwards towards the back side 104 an amount defined by the interior dimple or depression to maintain the same thickness, or it may not. In essence forming a protrusion extending from the wall of the closed-end 130 towards the front side 102 of the main body.

In other or the same embodiments, one or more of a circular or oval thinning in the wall of the closed-end 130 of the tube-like structure 122 may be used to define the cervix 126 and/or cervix opening 128. By “circular or oval thinning”, it is meant a circular or oval region on the wall of the closed-end 130 of the tube-like structure 122 where the material is thinner. For example, to define the cervix 126, a circular or oval thinning may be used whereby the wall material is thinner than the wall at radially outward positions. To define the cervix opening 128, a circular or oval thinning may again be used whereby the wall material is thinner than the wall defining the cervix 126. Alternatively, to define the cervix opening 128, the thickness of the wall be increased in that region as compared to the circular or oval thinning defining the cervix 126. As will be appreciated, various different combinations of circular or oval striations, circular or oval impressions, or circular or oval protrusions may be used to create and define the cervix 126 and/or cervix opening 128 in the wall of the closed-end 130 of the tube-like structure 122.

In other or the same embodiments, one or more of a conical structure or a ring-like structure in the wall of the closed-end 130 of the tube-like structure 122 may be used to define the cervix 126 and/or cervix opening 128. In an embodiment, the conical structure or ring-like structure protrude axially outwards from an inner surface of the wall of the closed-end 130. As contemplated herein, a ring-like structure differs from a circular protrusion in that a ring-like structure has a inner void space within the ring, whereas a circular protrusion may not as it may be filled circular structure (not a ring).

In an embodiment, the cervix 126 is defined by a single ring-like structure protruding axially outwards from an inner surface of the wall of the closed end 130, and the cervix opening 128 is defined by an inner void space within the ring-like structure.

Having regard to the teachings of the disclosure herein, the skilled person will appreciate that various other structural features and/or components may be used to make visual a cervix 126 and/or cervical opening 128 at or near the distal end of the tube-like structure. Merely as a non-limiting example, the cervix 126 and/or cervical opening 128 may be defined by a mold or casting that is inserted or positioned within the tube-like structure 122 at or near the distal end from the back side. Such a mold or cast may, for example, comprise a conical structure positioned axially within the tube like structure 122, the conical structure narrowing in diameter as it progresses towards the front side 102 of the main body 100. The mold or cast may further comprise a tube with the conical structure positioned axially therein. Although such embodiments are possible, configuring an insert (e.g. mold or cast) in a manner such that the cervix 126 and/or cervical opening 128 becomes an illuminated visual cervix 126 and cervix opening 128, as described herein, may not be cost efficient.

Viewed from the front side 102 (see FIG. 1), a user is able to view into the opening of the pliable vulvar opening 108 and down the vaginal canal defined by the interior of the main body 100 and posterior canal of the tube-like structure 122. In doing so, it is possible to view features of the female pelvic educational model of the present disclosure defining one or both of a cervix 126 and a cervix opening 128. In an embodiment, and depending on the size of the opening of the pliable vulvar opening 108 and the diameter and alignment of the tube-like structure, it is also possible to view one or more portions of the proximal end of the vaginal wall 130 defined by the posterior canal of the tube-like structure 122.

The main body 100 of the female pelvic educational model of the present disclosure may be made of any suitable material. In an embodiment, the main body 100 is made or comprised of a natural rubber, synthetic rubber, urethane, polyurethane, silicone, or any equivalent or combination thereof. In an embodiment, the main body 100 is made of silicone.

In an embodiment, the entirety or a portion of the material (e.g. silicone) of the main body 100 has a hardness as measured according to the Shore 00 hardness scale of between 0 and 30. In an embodiment, the entirety or a portion of the material (e.g. silicone) of the main body 100 has a hardness as measured according to the Shore A hardness scale of between 0 and 30. In an embodiment, the entirety or a portion of the material (e.g. silicone) of the main body 100 has a Shore hardness as measured according to standard ASTM D2240 of between 00-30. In an embodiment, certain components or features of the main body 100 may be of a different hardness. For example, in an embodiment the smooth outer portion 106 defining a labia majora may have a greater hardness than the opposing flap-like structures 110 defining labia minora. In another embodiment, the entirety of the main body has the same hardness.

In an embodiment of the female pelvic educational model of the present disclosure, the material of the main body 100 has a tensile strength of between about 100 psi and about 300 psi, more particularly between about 150 psi and about 250 psi. In an embodiment, the tensile strength is about 200 psi. In an embodiment, the material of the main body 100 has a 100% Modulus of between about 5 psi and about 15 psi. In an embodiments, the 100% Modulus is about 10 psi. In an embodiment, the material of the main body 100 has a tensile strength of about 200 psi and a 100% Modulus of about 10 psi.

In an embodiment of the female pelvic educational model of the present disclosure, the material of the main body 100 has an elongation at break % of between about 85% and about 95%. In an embodiment, the elongation at break % is about 90%.

In an embodiment of the female pelvic educational model of the present disclosure, the material of the main body 100 has a Die B tear strength of between about 30 pli and about 40 pli. In an embodiment, the a Die B tear strength is about 38 pli.

In an embodiment, the female pelvic educational model of the present disclosure further comprises a stand 200. In an embodiment, any suitable stand 200 may be used.

In an embodiment, the stand 200 is of a preferred configuration as disclosed herein, whereby the stand 200 orients the posterior canal defined by the tube-like structure 122 at an angle of 30° to 60° relative to a surface on which the stand 200 sits. In an embodiment, the angle is about 45° relative to a surface on which the stand 200 sits. It has been determined through extensive work and effort that the combination of features of the main body 100 of the present disclosure, including an extended vaginal canal and a visible cervix 126 and cervix opening 128 are best oriented at around a 45° angle for conducting anatomical simulations, and in particular for hand-free anatomical simulations whereby a user does not need to hold the main body 100. This combination of features of the female pelvic educational model of the present disclosure provides advantages in respect of utility of the model as an educational tool.

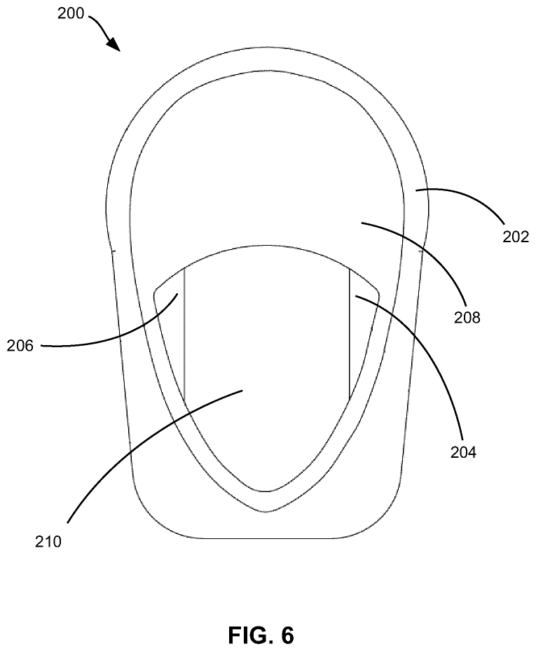

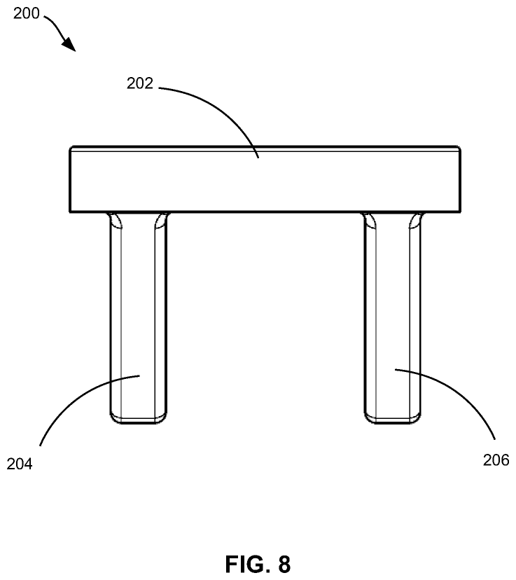

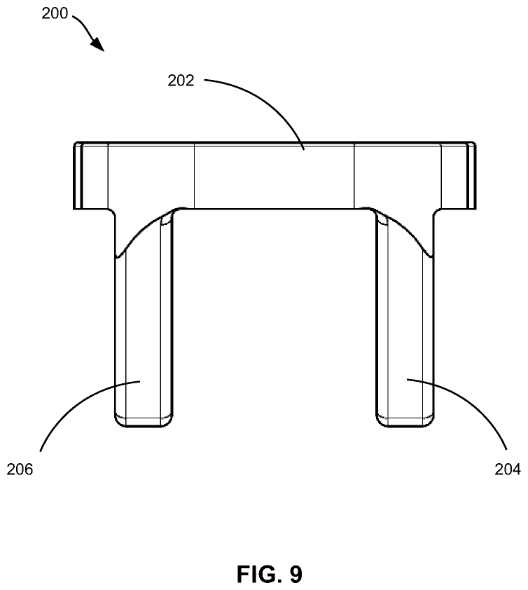

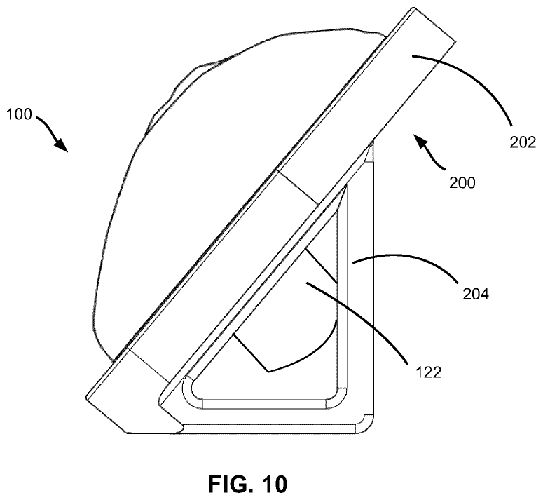

An exemplary embodiment of a stand 200 is represented in FIGS. 6-10. In FIG. 10, the main body 100 is shown engaged or resting upon the stand 200.

As can be seen, in an embodiment, the main body 100 sits upon and is detachably engaged to the stand 200. Thus, a user is able to remove the main body 100 from the stand 200, for example to assist in educational demonstrations or other applications. In addition, a single stand 200 may be used indefinitely. This is advantageous since many contemplated uses of the main body 100 for anatomical simulations may destroy the main body 100 (e.g. wound creation and suturing). Thus, while the main body 100 can be replaced, the stand 200 can be re-used.

In an embodiment, the stand 200 comprises a base 202 and one or more legs (204, 206). The base 202 may, for example, be a tabletop-like structure that sits upon the legs (204, 206) on a slanted angle to orient the tube-like structure 122 at a desired angle of between about 30° and about 60° relative to a surface on which the stand 200 sits. In an embodiment, the tabletop-like structure of the stand 200 may have an inwardly recessed portion 208 for receiving the main body 100, and upon which the main body 100 sits. This inwardly recessed portion 208 may conform to the exterior surface 124 of the back side 104 of the main body 100. Within this recessed portion 208, there may further be an aperture 210 through which the tube-like structure 122 of the main body 100 can pass (see FIGS. 6 and 10).

In an embodiment, the inwardly recessed portion 208 of the base 202 is a depth sufficient for the front side 102 to project and be positioned outside the recessed portion 208. In contrast, the back side 104 of the main body 100 may be completely recessed below the top of the tabletop-like structure of the base 202.

In an advantageous aspect herein, the back of the stand 200 in the area surrounding the tube-like structure 122 is open such that the tube-like structure 122, and optionally the back side 124, of the main body 100 can be exposed to a light source, natural or man-made. In an embodiment, the stand 200 may comprise one or more lights for exposing the tube-like structure 122, and optionally the back side 124, of the main body 100 to light.

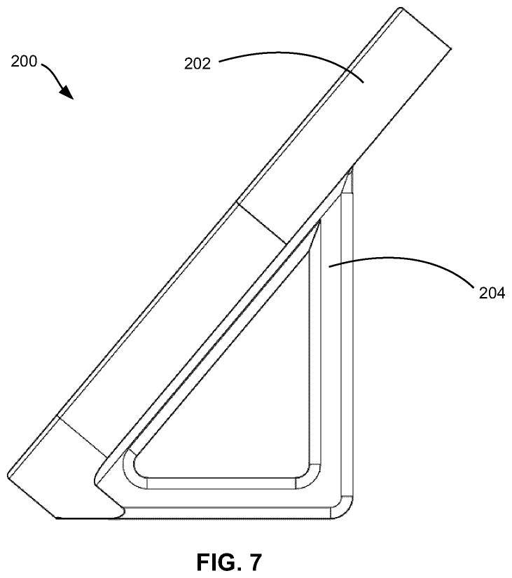

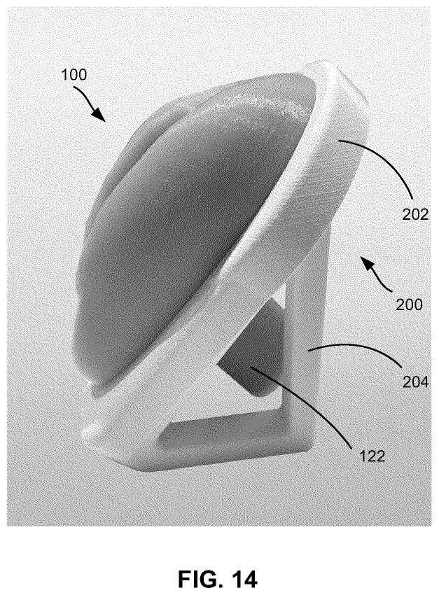

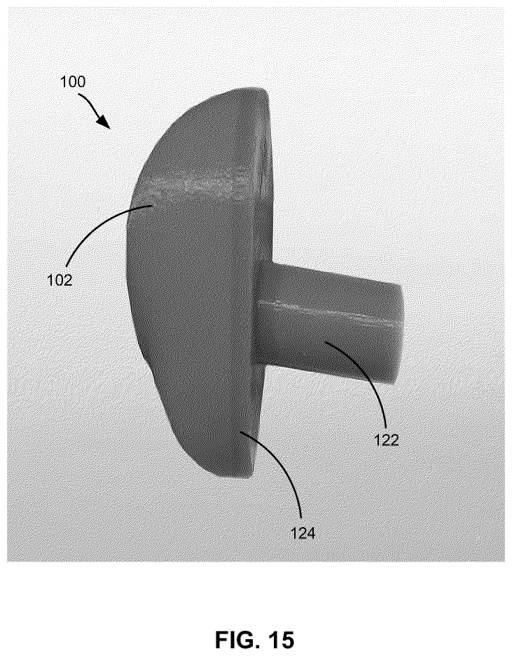

In an embodiment, the stand 200 comprises two legs (204, 206). In an embodiment, each of the two legs (204, 206) form a triangle shape by interconnection with opposing ends of the base 200, as shown in FIGS. 7 and 10. In an embodiment, the stand 200 comprises a sticky portion on a bottom surface of the one or more legs (204, 206). The sticky portions may provide further assistance in hands-free usage by assisting in retaining the stand 200 in its position on a surface. FIG. 14 is a colour photograph showing the main body 100 engaged with the stand 100. As can be seen comparing FIG. 14 and FIG. 15, the back side 104 is recessed with the base 202 of the stand 200.

In the female pelvic educational model of the present disclosure, the back side 104, or at least the tube-like structure 122 of the back side, is configured to allow for the passage of light into the interior of the main body 100 and the posterior canal within the tube-like structure 122 to provide an illuminated main body cavity having one or both of an illuminated visible cervix 126 and an illuminated visible cervix opening 128.

Referring to FIGS. 11-13, colour photographs of exemplary female pelvic educational models the present disclosure are provided. As can be seen, light passage into the interior of the main body 100 and into the tube-like structure 122 illuminates the vaginal wall 130 of the extended vaginal canal, the cervix 126, and/or the cervix opening 128. This provides a significant advantage as an educational tool and for anatomical simulations.

In an embodiment of the female pelvic educational model of the present disclosure, the entirety of the back side 104 is configured to allow for the passage of light into the interior of the main body 100 and the posterior canal with the tube-like structure 122. In other embodiments, only the tube-like structure 122 of the back side is configured to allow for the passage of light into the interior of the main body and the posterior canal within the tube-like structure 122. In an embodiment, the wall of the closed-end 130 of the tube-like structure 122 is configured to allow for the passage of light to further accentuate an illuminated visible cervix 126 and/or an illuminated visible cervix opening 128.

In an embodiment, the female pelvic educational model of the present disclosure is configured to allow for the passage of light into the interior of the main body 100 and the posterior canal within the tube-like structure 122 by one or more of (i) the material of the back side 104 being thinner than the material of the front side 102, (ii) the material of the back side 104 having a lower pigment density than the material of the front side 102, and (iii) the material of the back side 104 being a different colour than the material of the front side 102. In this paragraph, by “material of the back side”, it is meant to refer to one or both of the exterior surface 124 and tube-like structure 122 of the back side 104. In a particular embodiment, both the exterior surface 124 and tube-like structure 122 of the back side 104 are configured in one or more of the described manners.

In an embodiment, the female pelvic educational model of the present disclosure is configured to allow for the passage of light into the interior of the main body 100 and the posterior canal within the tube-like structure 122 by the material of the exterior surface 124 and tube-like structure 122 of the back side 104 being thinner than the material of the front side 102.

In an embodiment, the female pelvic educational model of the present disclosure is configured to allow for the passage of light into the interior of the main body 100 and the posterior canal within the tube-like structure 122 by the material of the exterior surface 124 and tube-like structure 122 of the back side 104 having a lower pigment density than the material of the front side 102.

In an embodiment, the female pelvic educational model of the present disclosure is configured to allow for the passage of light into the interior of the main body 100 and the posterior canal within the tube-like structure 122 by the material of the exterior surface 124 and tube-like structure 122 of the back side 104 being a different colour than the material of the front side 102.

In an embodiment, the female pelvic educational model of the present disclosure is configured to allow for the passage of light into the interior of the main body 100 and the posterior canal within the tube-like structure 122 by the material of the exterior surface 124 and tube-like structure 122 of the back side 104 being thinner than the material of the front side 102 and having a lower pigment density than the material of the front side 102.

In an embodiment, the female pelvic educational model of the present disclosure is configured to allow for the passage of light into the interior of the main body 100 and the posterior canal within the tube-like structure 122 by the material of the exterior surface 124 and tube-like structure 122 of the back side 104 being thinner than the material of the front side 102 and being a different colour than the material of the front side 102.

In an embodiment, the female pelvic educational model of the present disclosure is configured to allow for the passage of light into the interior of the main body 100 and the posterior canal within the tube-like structure 122 by the material of the exterior surface 124 and tube-like structure 122 of the back side 104 having a lower pigment density than the material of the front side 102 and being a different colour than the material of the front side 102.

In an embodiment, the female pelvic educational model of the present disclosure is configured to allow for the passage of light into the interior of the main body 100 and the posterior canal within the tube-like structure 122 by the material of the exterior surface 124 and tube-like structure 122 of the back side 104 being thinner than the material of the front side 102, having a lower pigment density than the material of the front side 102, and being a different colour than the material of the front side 102.

In an embodiment of the female pelvic educational model of the present disclosure, the back side 104 is a pink colour. In an embodiment, the front side 102 is a flesh tone colour. By “flesh tone colour”, it is meant a colour matching the colour of a person's skin. It may be a person of any race and/or ethnicity. As an exemplary embodiment, FIG. 15 is a photograph showing the front side 102 in a flesh tone colour and the back side 104 in a pink colour. As can be seen, the back side 104 comprises an exterior surface 124 that form the a back wall on the main body and the tube-like structure 122 extends outwards therefrom.

In an embodiment, the light is natural light to provide the illuminated vaginal wall 130 of the extended vaginal canal, the illuminated visible cervix 126, and/or the illuminated visible cervix opening 128. In other embodiments, the light is man-made, such as for example by lights on the stand 200 as described herein. In other embodiments, the light is a combination of natural light and man-made light.

Advantageously then, embodiments of the present disclosure provide an illuminated vaginal wall 130 of the extended vaginal canal, an illuminated visible cervix 126, and/or an illuminated visible cervix opening 128 within the female pelvic educational model disclosed herein. This is particularly useful for use of the female pelvic educational model disclosed herein as an educational tool, such as in anatomical simulations.

In another embodiment, the present disclosure relates to a kit for conducting anatomical simulations, the kit comprising: the main body 100 of the female pelvic educational model as described herein; and a stand 200. In an embodiment of the kit, the stand 200 is a stand as described herein.

In an embodiment, the kit disclosed herein further comprises a procedural tool, a swab, a lubricating substance, a feminine hygiene product or applicator, or any combination thereof. In an embodiment, the procedural tool is a pap or pelvic exam instrument, a contraception device, a dilator device, a device for sexual health, a massage device, or a pelvic wand.

In an embodiment, the kit disclosed herein further comprises instructions for use of the female pelvic educational model in one or more anatomical simulations.

In another embodiment, the present disclosure relates to the use of the female pelvic educational model as described herein for performing an anatomical simulation.

It is contemplated and has been found that the female pelvic educational model as described herein is particularly useful to Pelvic Floor Physiotherapists (PVPs). However, due to the all-encompassing nature of the female pelvic educational model disclosed herein, it has additionally been utilized in-clinic by sexual health educators, midwives, doulas, nurses, OB/GYNs, and healthcare students. The female pelvic educational model disclosed herein has provided numerous advantages over prior existing technologies, including without limitation rigid skeletal pelvic models, illustrations (published or hand drawn), puppets, and verbal descriptions.

Without accurate visual tools, such as provided by the female pelvic educational model herein providing an illuminated vaginal wall 130 of the extended vaginal canal, an illuminated visible cervix 126, and/or an illuminated visible cervix opening 128, such methods do not adequately educate patients about their anatomy, the proper placement of devices in their bodies, or how medical procedures are specifically conducted. In contrast, without limitation, the female pelvic educational model of the present disclosure can be used to demonstrate: perineal massage techniques (pre and post-partum), pap smears, pelvic exam procedures, contraception medical device insertion and removal (IUD's), female hygiene product (tampons, menstrual cups, discs) insertion and removal, dilator usage, sexual health techniques, anatomy lessons, and so on.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

It should be understood that while the models, stands, kits and uses are described herein in terms of “comprising,” “containing,” or “including” various components, features or steps, the compositions and methods can also “consist essentially of” or “consist of” the various components, features and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are dis-cussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1. A female pelvic educational model comprising:
a main body having a front side and a back side,
the front side having a shape defining a vulva and comprising an opening to an interior of the main body; and
the back side comprising an exterior surface and a tube-like structure extending outwards therefrom defining within a posterior canal, wherein the tube-like structure is open to the interior of the main body to form a vaginal canal with the opening in the front side,
wherein inside the tube-like structure at or near the end distal to the back side are one or more striations, impressions, protrusions, conical structures, ring-like structures, or any combination thereof, defining one or both of a cervix and a cervix opening; and
wherein the back side, or at least the tube-like structure of the back side, is configured to allow for the passage of light into the interior of the main body and/or the posterior canal to provide an illuminated main body cavity having one or both of an illuminated visible cervix and an illuminated visible cervix opening.

2. The female pelvic educational model of claim 1, wherein the exterior surface of the back side is a flat surface bounded by the shape defining the vulva of the front side.

3. The female pelvic educational model of claim 1, wherein the tube-like structure has a closed end distal to the back side of the main body.

4. The female pelvic educational model of claim 3, wherein the wall formed by the closed end of the tube-like structure comprises one or more of a circular or oval striation, a circular or oval impression, a circular or oval protrusion, the conical structure, the ring-like structure, or any combination thereof, to define the cervix and the cervix opening.

5. The female pelvic educational model of claim 4, wherein the circular or oval impression is a circular or oval dimple and/or circular or oval thinning of material defining the cervix opening.

6. The female pelvic educational model of claim 4, wherein the cervix is defined by a single ring-like structure protruding axially outwards from an inner surface of the wall formed by the closed end.

7. The female pelvic educational model of claim 6, wherein the cervix opening is defined by an inner void space within the ring-like structure.

8. The female pelvic educational model of claim 1, wherein the entirety of the back side is configured to allow for the passage of light into the interior of the main body and the posterior canal.

9. The female pelvic educational model of claim 1, wherein only the tube-like structure of the back side is configured to allow for the passage of light into the interior of the main body and the posterior canal.

10. The female pelvic educational model of claim 1, which is configured to allow for the passage of light into the interior of the main body and the posterior canal by the material of the back side being thinner than the material of the front side.

11. The female pelvic educational model of claim 1, which is configured to allow for the passage of light into the interior of the main body and the posterior canal by the material of the back side having a lower pigment density than the material of the front side.

12. The female pelvic educational model of claim 1, which is configured to allow for the passage of light into the interior of the main body and the posterior canal by the material of the back side being a different colour than the material of the front side.

13. (canceled)

14. (canceled)

15. The female pelvic educational model of claim 1, wherein the shape defining the vulva comprises:
a smooth outer portion defining a labia majora; and
a pliable vulvar opening formed by opposing flap-like structures defining labia minora, the pliable vulvar opening situated between the smooth outer portion,
wherein an upper region within the pliable vulvar opening comprise a solid surface set internal to the labia majora and a lower region comprises the opening to the interior of the main body and allows for passage into the posterior canal defined by the tube-like structure.

16. The female pelvic educational model of claim 15, wherein the smooth outer portion further comprises a circular crevice defining an anus, the circular crevice being below the pliable vulvar proximal to the lower region.

17. The female pelvic educational model of claim 15, wherein the smooth outer portion further comprises a protruding ridge extending from a top of the main body to just above or between the opposing flap-like structures defining labia minora, the protruding ridge being proximal to the solid surface set internal to the labia majora and defining a clitoral hood with a clitoris at the position just above or between the opposing flap-like structures.

18. The female pelvic educational model of claim 15, wherein the solid surface set internal to the labia majora comprises a circular inlet or depression defining a urethra.

19. The female pelvic educational model of claim 1, wherein the main body is made of silicone with a Shore A value of between 0 and 30 and the smooth outer portion has a higher Shore value than the pliable vulvar opening.

20. (canceled)

21. The female pelvic educational model of claim 1, wherein the main body has one or more of a tensile strength of about 200 psi and a 100% Modulus of about 10 psi; an elongation at break % of about 90%; and a Die B tear strength of about 38 pli.

22. (canceled)

23. (canceled)

24. The female pelvic educational model of claim 1, further comprising a stand.

25. The female pelvic educational model of claim 24, wherein the stand orients the posterior canal defined by the tube-like structure at an angle of 30° to 60° relative to a surface on which the stand sits.

26. (canceled)

27. The female pelvic educational model of claim 25, wherein the main body sits upon and is detachably engaged to the stand.

28. The female pelvic educational model of claim 24, wherein the stand comprises a base and one or more legs, the base having an aperture to receive the tube-like structure of the main body.

29. The female pelvic educational model of claim 28, wherein the back side of the main body rests upon an inwardly recessed portion of the base, the inwardly recessed portion defining the aperture.

30. The female pelvic educational model of claim 29, wherein the inwardly recessed portion of the base is a depth sufficient for the front side to project and be positioned outside the recessed portion.

31. The female pelvic educational model of claim 24, wherein the stand comprises two legs, each of the two legs forming a triangle shape by interconnection with opposing ends of the base.

32. The female pelvic educational model of claim 24, wherein the stand comprises a sticky portion on a bottom surface of the one or more legs.

33. A kit for conducting anatomical simulations, the kit comprising:
the female pelvic educational model of claim 1; and
a stand.

34. (canceled)

35. The kit of claim 33, further comprising a procedural tool, a swab, a lubricating substance, a feminine hygiene product or applicator, or any combination thereof.

36. The kit of claim 35, wherein the procedural tool is a pap or pelvic exam instrument, a contraception device, a dilator device, a device for sexual health, a massage device, or a pelvic wand.

37. (canceled)

38. (canceled)
